(19) United States
(12) Patent Application Publication
(10) Pub. No.: US 2017/0312634 A1
(43) Pub. Date: Nov. 2, 2017

(54) SYSTEM AND METHOD FOR PERSONALIZED AVATAR GENERATION, ESPECIALLY FOR COMPUTER GAMES

(71) Applicant: URANIOM, Laval (FR)

(72) Inventors: Loïc LEDOUX, Paris (FR); Nicolas HERIVEAUX, Roubaix (FR)

(21) Appl. No.: 15/141,558

(22) Filed: Apr. 28, 2016

(51) Int. Cl. A63F 13/63; A63F 13/25; G06T 15/00

(52) U.S. Cl. CPC A63F 13/63; G06T 15/005; A63F 13/25; G06T 2219/024

(57) ABSTRACT

A system and method for generating a 3D personalized avatar including a computerized server, a computerized client device, a bidirectional communications channel between the server and the client device, a memory in the client device, storing 3D scan data of at least part of a user's body, a memory in the server stores the 3D scan data received from the client device. A plurality of 3D model data sets are stored in the server memory. A gaming system selector provides information about a gaming system selected for personalized avatar generation. A personalized 3D avatar generation engine is responsive to the selected gaming system for merging the user 3D scan data with a 3D model data set. An avatar package generator generates a personalized avatar package containing the merged data. An avatar package installer in the client device receives the package and makes the personalized 3D avatar accessible to the selected gaming system.

### FIELD ON THE INVENTION

The present invention generally relates to the field of customized or personalized avatar generation in 3D computer-executed applications such as 3D video games.

### BACKGROUND OF THE INVENTION

Nowadays many games provide user interfaces and related avatar generation processes for generating custom avatars.

For instance, a user, by choosing face (and possibly body) items and features such as skin color, hair color, hair cut, and among various shapes for the face contour, the eyes, the nose, the mouth, the ears, can create a personalized avatar which will be displayed in an animated fashion when the video game is executed.

In many instances, a user tries to create an aspect of a virtual game actor that fits best his/her own aspect, but this is tedious and very often impossible to achieve satisfactorily, taking into account in particular the limited number of elementary “bricks” (face shape, skin color, eyes shape and color, mouth shape, nose shape, hair color and cut, mustache, beard, etc.) that can be assembled together to form a customized aspect of a virtual game actor.

### SUMMARY OF THE INVENTION

The present invention seeks to overcome these limitations of first-person type games or other applications by allowing a user to generate an avatar based on his/her own appearance, in a straightforward and streamlined manner.

To this end, the present invention provides according to a first aspect a system for generating a 3D personalized avatar for use in gaming applications or the like, comprising:
a computerized server,
a computerized client device,
a bidirectional communications channel between said server and said client device,
a memory in said client device, storing 3D scan data of at least part of a user's body,
a memory in said server for storing said 3D scan data after transmission from said client device through said bidirectional communications channel,
a plurality of 3D model data sets associated to a plurality of gaming systems, stored in said server memory,
a gaming system selector for providing to server information about a gaming system selected for personalized avatar generation,
a personalized 3D avatar generation engine provided in said server and responsive to the selected gaming system for merging said user 3D scan data with a 3D model data set associated with the selected gaming system,
an avatar package generator provided in said server for generating a personalized avatar package containing said merged data, and
an avatar package installer provided in said client device for receiving said package from said server through said communications channel and for making the personalized 3D avatar accessible to the selected gaming system.

Preferred but non-limiting aspects of the system comprise the following features, taken individually or in any technically compatible combinations:
said user 3D scan data are unoriented scan data, and said server further comprises a 3D scan data analyzer configured for receiving from said client said unoriented 3D scan data, for generating and storing a plurality of 2D renderings of said unoriented 3D scan data from a corresponding plurality of different viewpoints, for performing image analysis on each 2D rendering for identifying and locating characteristic body and/or head areas, for selecting a best 2D view including the best found characteristic areas, and for processing said unoriented 3D scan data so that they refer to head or body axes.
said unoriented 3D scan data comprise head data and said 3D scan data analyzer is configured for identifying characteristic areas corresponding to eyes and mouth in said renderings.
said 3D scan data analyzer is configured for performing a fine reorientation of the unoriented 3D scan data from the positions of said characteristic areas in the best 2D view.
said server comprises a universal scan file generator for generating scan files containing data capable of being merged with a plurality of different formats corresponding to said 3D model data sets.
said universal scan file generator is capable of generating a first scan file of higher definition adapted for use by said avatar generation engine and a second scan file of lower definition adapted for display in a client device.
said client device are configured for interactive avatar parameter adjustment by transmitting low definition scan data from said server to said client device, for computing at client side changes in the 3D scan aspect in response to parameter changes also made at client side, and for displaying the changed 3D scan aspect as parameters are changed.
said client device is configured to transmit the final avatar parameters to said server, said parameters being used by said avatar generation engine for processing said user 3D scan data before merging.
said avatar generation engine is configured for determining whether 3D points are located within the scan area, or within the model area, or else in a transition area between the scan and the avatar, and selecting which model data are to be replaced with scan data or combined with scan data based on such determination, for generating a merged 3D structure.
the coordinates of a pair of boundaries are associated with the stored 3D models, a first boundary extending between the scan area and the transition area, and a second boundary extending between the transition area and the model area.
the coordinates of the merged 3D structure in the transition area are determined by interpolation between scan coordinates and model coordinates.
said interpolation uses interpolation coefficients that vary gradually from the first boundary to a second boundary to ensure a smooth shape transition between the 3D scan in the scan area and the 3D model in the model area.
said avatar generation engine is further configured to gradually mix the textures of the 3D scan and the textures of the 3D model in the transition area.

According to a second aspect, the present invention provides a computer-implemented method for generating a 3D personalized avatar for use in gaming applications or the like, comprising:
generating and transmitting to a server 3D scan data of at least part of a user's body and storing said scan data in a server memory,
providing a plurality of 3D model data sets associated to a plurality of gaming systems in said server memory,
selecting a particular gaming system among said plurality of gaming systems,
generating a personalized 3D avatar by merging said user 3D scan data with a 3D model data set associated with said selected gaming system,
generating an avatar package containing said merged data in said server,
transmitting said avatar package to a client device connectable to gaming system of the selected type, and
installing said avatar package in said client device for making the personalized 3D avatar accessible to said gaming system.

Preferred but non-limiting aspects of the method comprise the following features, taken individually or in any technically compatible combinations:
said user 3D scan data are unoriented scan data and the method further includes:
generating from said unoriented 3D scan data a plurality of 2D renderings of said unoriented 3D scan data from a corresponding plurality of different viewpoints,
performing image analysis on each 2D rendering for identifying and locating characteristic body and/or head areas,
selecting a best 2D view including the best found characteristic areas, and
processing said unoriented 3D scan data so that they refer to head or body axes.
said unoriented 3D scan data comprise head data and said characteristic areas correspond to eyes and mouth in said renderings.
the method comprises the further step of performing a fine reorientation of the unoriented 3D scan data from the positions of said characteristic areas in the best 2D view.
the method comprises the step of generating from said 3D scan data a universal scan file containing data capable of being merged with a plurality of different formats corresponding to said 3D model data sets.
the method comprises the generation of a first scan file of higher definition adapted for use for avatar generation and a second scan file of lower definition for display in a client device.
the method comprises a further step of adjusting scan parameters by:
transmitting a low-definition scan file from said server to said client device,
performing parameter changes at said client device,
computing at said client device changes in the 3D scan aspect in response to said parameter changes, and
displaying of a client device display the correspondingly changing 3D scan aspect.
the method comprises a further step of transmitting from said client device to said server the final avatar parameters, said parameters being inputted to the avatar generation step.
the avatar generation step comprises determining whether 3D points are located within the scan area, or within the model area, or else in a transition area between the scan and the avatar, and selecting which model data are to be replaced with scan data or combined with scan data based on such determination.
the coordinates of a pair of boundaries are associated with the stored 3D models, a first boundary extending between the scan area and the transition area, and a second boundary extending between the transition area and the model area.
the coordinates of the merged 3D structure in the transition area are determined by interpolation between scan coordinates and model coordinates.
said interpolation uses interpolation coefficients that vary gradually from the first boundary to a second boundary to ensure a smooth shape transition between the 3D scan in the scan area and the 3D model in the model area.
said avatar generation step further comprises gradually mixing the textures of the 3D scan and the textures of the 3D model in the transition area.

### BRIEF DESCRIPTION OF THE DRAWINGS

Other aims, features and advantages of the present invention will appear more clearly from the following description of a preferred embodiment thereof, given by illustration only and made with reference to the appended drawings, in which:

FIG. 1 is a block-diagram of a client-server architecture in which the present invention can be embodied,

FIG. 2, is a flow-chart of a general outline of the present invention methods,

FIG. 3 illustrates a method for analyzing a client-provided raw 3D scan according to the present invention,

FIG. 4 illustrates a method for generating a universal 3D scan according to the present invention,

FIG. 5 illustrates a method for avatar adjustment according to the present invention,

FIG. 6 illustrates a method of avatar generation for preview purposes for use in the adjustment method of FIG. 5, according to the present invention,

FIG. 7 illustrates a method for generating an avatar package for loading in a game application, according to the present invention,

FIG. 8 illustrates a merging method according to the present invention, for use in the preview avatar and avatar package generation methods of FIGS. 6 and 7,

FIG. 9 illustrates a method for avatar installation according to the present invention

FIG. 10(I) illustrates a set of 2D representations derived from raw 3D data, used in the method of FIG. 3,

FIG. 10(II) illustrates a set of 2D representations derived from raw 3D data, used in the method of FIG. 3,

FIG. 11 illustrates how coefficients impacting facial animation based on vertex/bone segments are determined, and

FIG. 12 is a diagrammatic side view of a final 3D structure with planes separating a scan area, a model area and a transition area therebetween.

### DETAILED DESCRIPTION OF A PREFERRED EMBODIMENT

### 1) Hardware Architecture

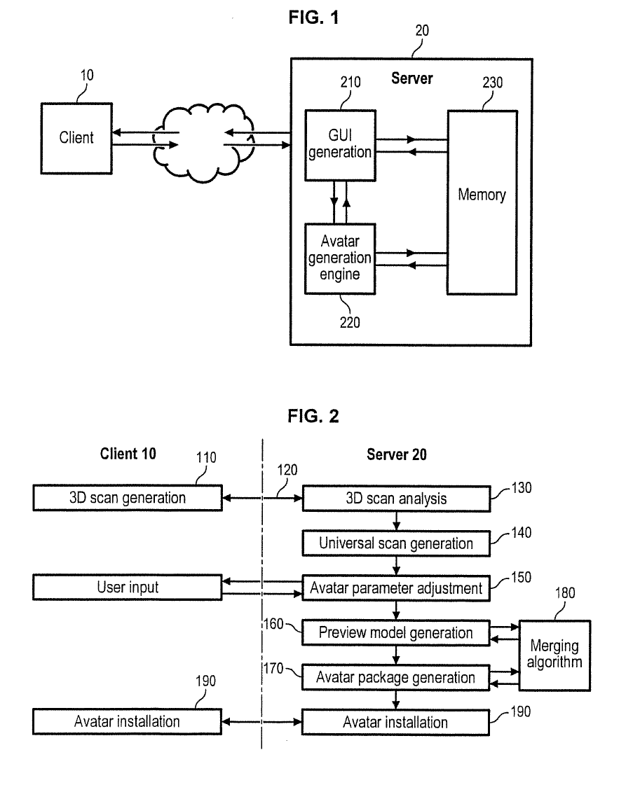

Referring to FIG. 1, a client device 10 such as a PC, Apple Macintosh, a Windows®-, IOS®- or Android®-based tablet or smartphone is connected to a server 20 via an appropriate network connection, e.g. according to TCP/IP protocol.

Server 20 comprises a conventional computing architecture with processor, memories and I/O circuits, functionally defining together a graphical user interface (GUI) generation unit 210 for providing a user interface to client device 10 and for collecting instructions therefrom, and an avatar generation engine 220 cooperating with memory 230 for performing the various server-side methods as will be described in the following.

### 2) Overview

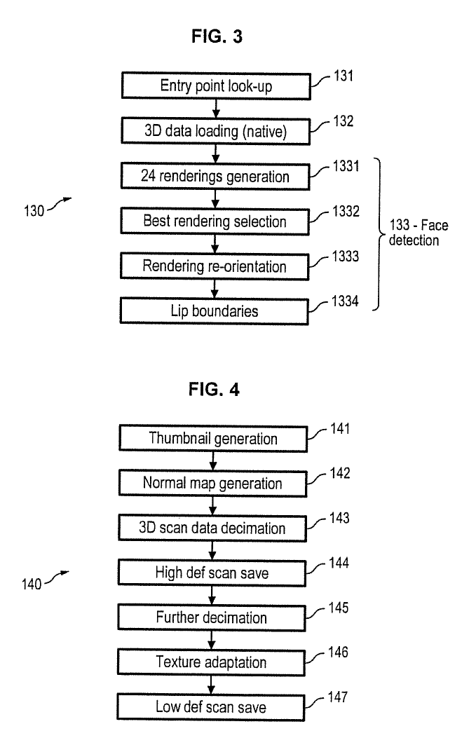

Now referring to FIG. 2, a process for personalized avatar generation according to the present invention comprises the following main methods:
Method 110—raw scan generation: a 3D scan of the user's face is generated at client side: this can be performed at home, e.g. with a smartphone or tablet provided with a camera and with dedicated software embarked therein. A 3D scan file is generated. Different formats exist for such file. They include the .obj, .ply, .fbx formats in particular. Wikipedia among others provides details about these formats. They all define a 3D structure with vertices, facets, and colors, textures and transparencies for each of the facets. Alternatively, this can be performed with a dedicated 3D scan generation apparatus, as commercially available;
Method 120—scan package transmission: the scan package generated at step 110 is made available at a user terminal level (smartphone, tablet, PC, etc.) and uploaded to server 20 via network 30;
Method 130—3D scan analysis: server 20 performs an analysis of the uploaded 3D scan package, as will be described with reference to FIG. 3;
Method 140—universal 3D scan file generation: server 20 generates a universal scan file for use in avatar generation;
Method 150—server 20 interacts with client 10 so as to adjust avatar parameters used for avatar generation;
Method 160—server 20 generates a preview model of avatar;
Method 170—server 20 generates final avatar package;
Method 190—server 20 interacts with client 10 for avatar package installation in client-hosted game application.

Both methods 160 and 170 rely on a merging process (method 180) for combining an avatar model corresponding to a selected game or game family and the universal 3D scan data generated at step 140, taking into account the adjustment parameters collected by server at step 140.

The above methods will now be described in detail.

### 3) 3D Scan Analysis

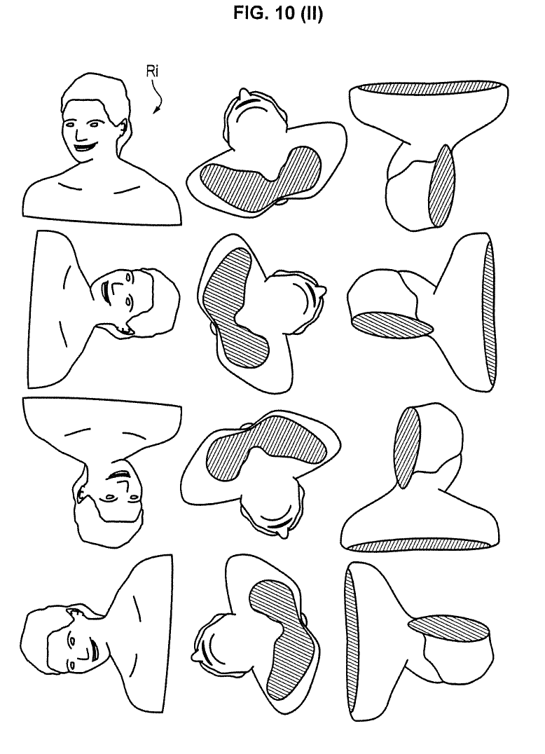

Now referring to FIG. 3, method 130 includes the following steps:
step 131: look-up for an “entry point” file in the 3D scan package, containing the raw 3D geometrical data of the user's face, and identification of the file format; this is achieved by storing beforehand in server memory 230 information about the internal structures of various exploitable 3D scan formats;
step 132: loading the raw 3D geometrical data in the native file format (.obj, .ply, .fbx, etc.);
step 133: searching for a face shape in the 3D geometrical data; it should be noted here that the raw 3D scan data normally contain no indication as to whether they contain a head or a full body, no scale indication, no reference orientation; this step is performed by:
   sub-step 1331: generating an array of twenty four renderings of the 3D san data from an arbitrary set of six view points (+X, −X, +Y, −Y, +Z, −Z, X, Y and Z being three mutually orthogonal axes) and each time with four different orientations of the 3D data (0°, 90°, 180° and 270°); an exemplary representation of such 24 views is diagrammatically illustrated in FIG. 10;
   sub-step 1332: among the 24 renderings, searching for the best-matching face; this can be performed e.g. by using the OpenCV “Haar Cascade” recognition program, details of which are available at http://docs.opencv.org/master/d7/d8b/tutorial_py_face_detection.html#gsc.tab=0, this program performing the following basic functions:
      determining a set of zones that may correspond to a face, the zone sorted by size and by relevance score;
      for each zone, from the best candidate to the worst candidate, search for a pair of eyes and a mouth, using Haar feature-based cascade classifiers, and selecting as best image among the twenty-four renderings the one containing the best face-matching zone; this rendering is shown as Ri in FIG. 10,
   sub-step 1333: the raw 3D scan then is reoriented using the one among the six viewpoints and the one among the four orientations corresponding to the best image as defined above; this is done by:
      performing a ray tracing toward the positions of the eyes and the mouth as detected by the Haar Cascade process, so as to determine the 3D coordinates thereof at the surface of the 3D scan,
      these three 3D-coordinates points form a spatial reference frame from which the face contained in the 3D data can be finely reoriented, i.e. a horizontal axis corresponding to the on-axis position of the face is defined;
   substep 1334: the lip boundaries are then determined by:
      performing a rendering centered on the mouth;
      by contrast detection, defining a plurality of lip boundary segments defining altogether the lip boundaries;
      storing the 3D coordinates of these lip boundary segments (each time a pair of 3D points between which the segment extends), allowing a subsequent generation of (animated) lip geometries.

### 4) Method 140: Universal Scan File Generation

This method generates universal high-definition and low definition data structures representative of the head with proper orientation as determined at step 130. It includes the following steps:
step 141: a low-definition 2D scan thumbnail of the reoriented best image containing the face is generated, for use as explained below;
step 142: a normal map of the 3D scan in its original definition, as viewed from the head axis is generated; this is done by parsing the scan polygons and writing the coordinates (x, y, z) of the normal vector interpolated to the position of each pixel in a texture;
step 143: the 3D scan data are decimated, e.g. with the commercially available VCG library, in order to simplify the subsequent treatments while retaining a number of polygons sufficiently large to preserve the details of the head;
step 144: a high-definition (HD) version of the 3D scan as obtained at step 143 is stored together with its normal map in an appropriate file format denoted UFF, such format being preferably universal in that it does not depend on a third party library for its handling and is extensible; in addition, the format is preferably adapted for direct handling by a usual library such as WebGL on the client side; details of the format will be provided in the following;
step 145: the 3D scan data are further decimated to a polygon density compatible with computer or tablet browser display;
step 146: the textures scale in said 3D data is adapted for compatibility with browser display;
step 147: a low-definition (LD) version of the 3D scan as obtained in steps 145 and 146 is stored, without normal map, in the universal scan format UFF as further explained below, for use in avatar adjustment method 150 as described below.

### 5) Method 150: Scan Parameters Adjustment

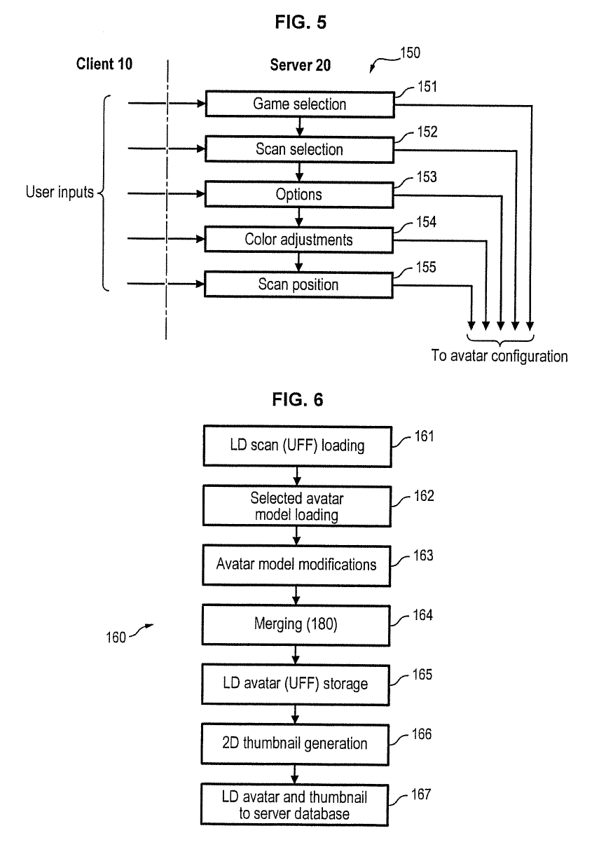

Now referring to FIG. 5, this method relies on a graphical user interface defined in block 210 of server 20 and made available to the client equipment 10 via network connection 30. It includes the following steps:
step 151: by interaction between his client device and server, from a menu, a particular video game or family of video games is selected by user from a server-generated menu displayed at client device: to each video game or video game family is associated a particular avatar format, as defined by the technical specifications of the respective games, which is predefined and stored in server memory in the form of a model as will be explained below; the selected video game or game family is transmitted to server AGS and stored therein for future use;
step 152: again by interaction between his client device and server, user selects one of the 3D scans processed by server according to method 130, by browsing among the scan thumbnails which preferably are associated with corresponding scan names;
step 153: client/server interaction allows user to select from menus certain options which depend on the game type or game family type, e.g. player gender, player type, skin color, team, class, etc.); values defining these options are defined and stored in server;
step 154: the scan preview is generated by server and transmitted to client device for display: at client level, user can adjust certain colorimetric parameters such as brightness, contrast and saturation; the corresponding adjustment effects are preferably computed directly at client level, allowing the user to check the effects of adjustments without potential lagging which could occur if computed at server level because of client-server communications time and server overloading;
step 155: the scan position (size, orientation, position) is fine-tuned; here again, the corresponding position adjustments are used directly at client level for recomputing and displaying scan appearance, allowing the user to check the effects of position adjustments.

The information and data collected at steps 151-155 are transmitted from client to server and there to the avatar generation engine 220, the latter then generating a new avatar configuration according to methods 160-180 as described in the following.

### 6) Method 160: Avatar Preview Model Generation

As illustrated in FIG. 6, method 160 includes the following steps:
step 161: the low definition scan data of the selected scan in the universal format UFF, as generated and stored at steps 145-147 of method 140, is loaded into working memory of engine 220;
step 162: an avatar model corresponding to the selected game or game family and to certain of the selected options (typically gender, player type, etc.) is loaded into engine working memory; avatar model also is in the universal format;
step 163: the avatar model is modified according to the remainder of the selected options including the adjustments made during execution of method 150 (typically skin color, texture, equipment, etc.);
step 164, the LD scan data and the avatar model data are merged using a merging process 180 as will be described below with reference to FIG. 8;
step 165: the avatar thus generated is stored in the UFF format, ready for transmission to client for preview in a browser, preferably using the WebGL library;
step 166: a 2D avatar thumbnail of the avatar is generated, for the purpose of avatar selection as explained later;
the LD avatar in the UFF format and the 2D thumbnail of the avatar are stored in server memory 230 for later retrieval and use.

### 7) Method 170: Avatar Package Generation

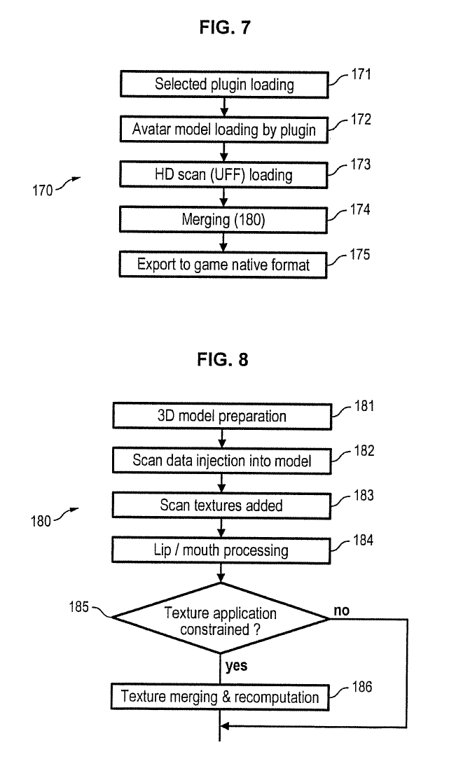

Now referring to FIG. 7, the method comprises the following steps:
step 171 a plugin dedicated to an avatar package generation suitable for the game or game family selected at step 151 is loaded from a plugin storage belonging to server memory 230;
step 172: the plugin loads the 3D model corresponding to the options selected by user; this model is pre-stored in a model storage space of server memory 230 in the native format of selected game or game family, and contains a graph of objects in object-oriented language such as C++, implementing the class model of the UFF 3D scan format;
step 173: the high-definition 3D scan file in UFF format, as generated at step 144, is loaded into working memory;
step 174: the 3D scan file is processed according to the parameters adjusted by method 150 and the processed 3D scan file and the model are merged by the merging process as described below;
step 175: the plugin then exports the 3D model into which the 3D scan file data have been merged into the native format of the game or game family, to form the avatar configuration in the form of a package.

### 8) Method 180: Merging Process

The merging process 180 mentioned in steps 164 and 174 will now be described with reference to FIG. 8.

An object model such as mentioned in step 172, corresponding to a particular game or game family and in the native format thereof, has the general structure defined as follows:
it can be made of any number of 3D geometrical objects in mesh form;
each mesh can have any number of surfaces, and each surface can contain any number of polygons and display-related information (material type, texture, transparency, etc.),
each polygon is defined by at least 3 vertex identifiers;
a mesh contains minimum basic information for each vertex, i.e. vertex position, normal to the surface at the vertex, texture data;
a mesh optionally contains additional information associated to each vertex, that will be interpolated by the merging process; such additional information includes for instance additional texture coordinates, tangent coordinates, bi-normal coordinates, bone weights for use by a skinning process, etc.;

It should be noted that various related information that do not fit into model format but need to be included in the final package are kept and stored separately in the server storage in association with the model; such data include for instance material properties and certain geometrical data for use by the game rendering engine. These data are included in the package generated at step 175.

The merging process is implemented by the plugin selected at step 171, which is configured to new files in the game native format, taking into account the changes brought to the 3D data geometry.

For this purpose, a 3D mathematical model is pre-established for each 3D model, this model allowing to determine whether a point having given 3D coordinates is located:
either within the scan area,
or within the model area,
or else in a transition area between the scan and the avatar,
   and in the latter case, to compute an interpolation coefficient between the scan and the model.

In one practical example, as illustrated in FIG. 12, the 3D mathematical model is well suited to the situation where the model comprises an area of the human body comprising the chest C (or a top region of the chest), the neck N and the head H, while the scan area typically comprises a similar area. However, to best fit with the game, the 3D data in the chest area should be those of the model data, the 3D data in the head area should be those of the 3D scan so that the player actually sees his own face, and the neck area is used as a transition area between the scan (head) and the model (chest).

In such case, the 3D mathematical model is capable of determining a first boundary, in the present species a first plane P1, in the top region of the neck and a second boundary, in the present species a second plane P2 preferably parallel to plane P1, in the bottom region of the neck.

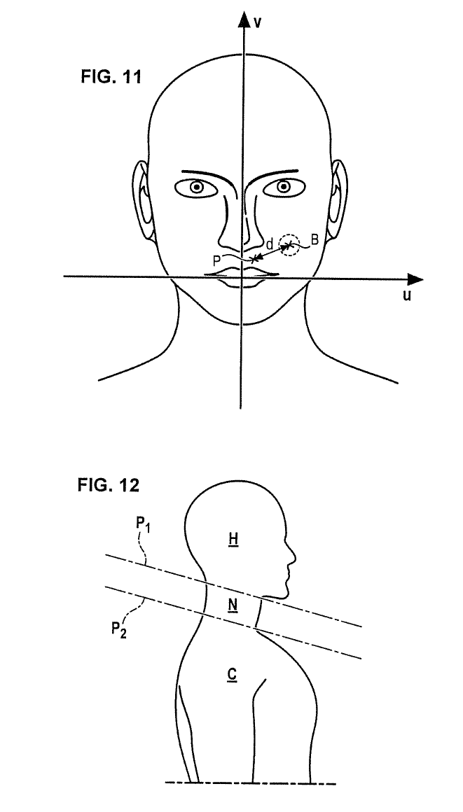

Once these planes have been defined, the merging process performs the following steps:
step 181: the 3D model is prepared for the merging:
   all the geometry of the model located within the scan area (i.e. above plane P1) is removed;
   the geometries of the scan data and the model data comprising all points located in the transition area between planes P1 and P2 are converted into a closed shape, so as to avoid display artifacts (holes in the display) generated by the fact that the scan cross-section in planes P1 and P2 is not identical to the model cross-section in these planes; this is done by closing the tubular geometries of the scan and model data in said transition area (corresponding to the neck) along said planes P1 and P2;
step 182: the scan data are injected into the 3D model by:
   deleting all the scan geometry located in the model area (i.e. below plane P2);
   decimating the remaining scan geometry so as to adapt the scan geometry (definition) to the technical requirement of the target game application; typically, this is done by using definition information associated with the model data and stored in the file in the UFF format;
   enriching the scan vertex information in the scan area with the above-mentioned additional information missing from the scan data themselves but present in the model; this is performed by interpolating the values of the additional information based on distance with of the scan surface;
   adding the scan geometry to the model, with vertex coordinates of the 3D scan unchanged;
   generating a transition geometry in the transition area by interpolating the vertex coordinates of the 3D scan with those of the 3D model, the interpolation coefficients being small in the vicinity of plane P1 and progressively larger toward plane P2, so that the 3D scan data in the transition area progressively become adjusted to the 3D model data at plane P2, thus avoiding discontinuities;
step 183: the scan textures are added to the 3D model by:
   rearranging each scan texture so that only the zones used by the scan after merging (i.e. head and neck areas in the present example) are used;
   in the transition area, mixing the scan textures of the scan polygons located with the model textures of the model polygons according to interpolation coefficients that vary gradually from the first boundary to the second boundary, so as to ensure a smooth visual transition between the scan textures used above plane P1 and the model textures used below plane P2, thus avoiding undesirable discontinuities;
   recomputing the scan texture coordinates so that they correspond to the rearranged vertices in the transition area.
step 184: if the plugin associated with the game application supports facial animation (which is determined by a flag or equivalent contained in the plugin), then the following is performed:
   the 3D scan polygons injected into the model are divided using the lip boundary segments determined at step 1334;
   a geometry of the inter-lip space of the mouth is generated and injected into the model;
   a set of 2D parameterizations of the geometry are computed in relation with certain interest zones of the face (eyes, mouth, . . . ); in particular, the influence of the head bone movements impacting facial animations is computed for each vertex, taking into consideration the distances between these vertices and the 2D parameterization of a head bone system stored in the model file in the UFF format; FIG. 11 illustrates the position of a vertex P and the position of a bone B, as well as the distance d between vertex and bone, that can be determined using the coordinates of P and B in a 2D coordinate system (u, v) of the head as illustrated; a coefficient can be allocated to each of the PB segments so as to determine a resulting vertex movement for any combination of bone movements, vertex by vertex, such coefficient being for instance inversely proportional to the length of the PB segment;
step 185: the plugin associated with the game application determines from data included in the plugin whether the game application requires that the texture application process is identical to the one of the original model;
in the affirmative, step 186 performs the following:
   the additional textures generated by injecting the scan into the model are merged with the original textures of the model to form a single texture by (i) identifying the zones of each texture which are actually used by parsing the polygons of the final geometry, (ii) determining an arrangement of these zones on a single texture, preferably by a process implementing a greedy algorithm solving a 2D “Bin packing” problem by using a ‘backpack’ type algorithm, known to the skilled person, and (iii) performing a copy of the pixels from said zones to their new positions in the single texture;
   the texture coordinates are recomputed using the data of each texture thus created, by linear transformation of the coordinates of the zones in the original texture to their new positions in the recombined texture.

The above model is only a possible embodiment, and the skilled person will be able to design other suitable 3D mathematical models (typically not based on separation planes) ensuring that a smooth geometrical and visual transition between the scan area and the model area is ensured.

### 9) Method 190: Avatar Installation

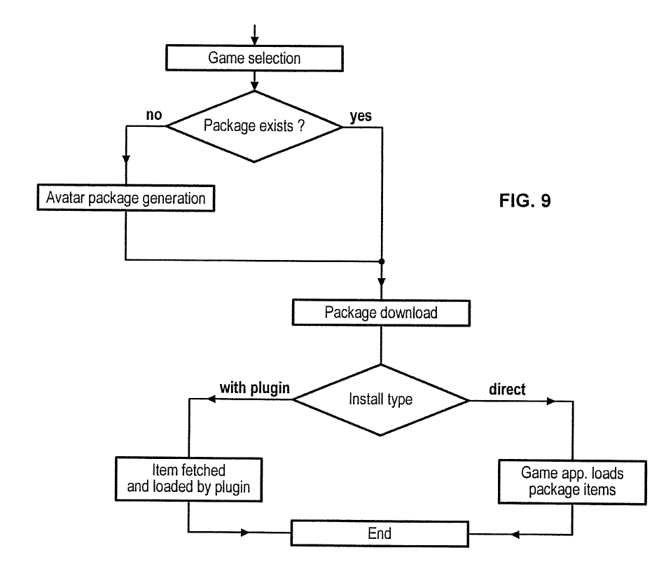

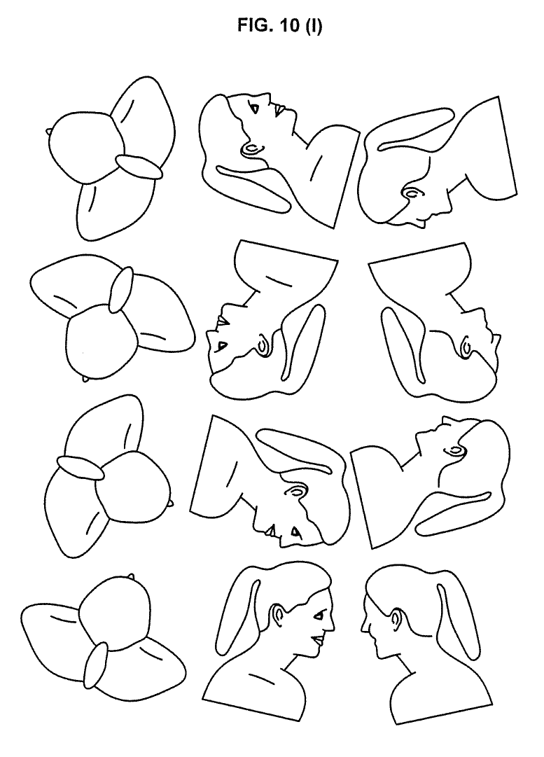

Now referring to FIG. 9, the method 190 for installing an avatar generated as described above as a resource of a game application will be described.

It should be noted here that certain game applications allow direct avatar loading, while other game applications require a specific program for including new avatars to the game. The game or game family information stored in server 20 includes a flag or the like giving such indication.

Method 190 comprises the following steps:
step 191: if the selected game application supports direct loading, the user connects with his client equipment to his user account in server 20, selects a game or game family, and then selects an existing avatar for this game/game family by browsing in a menu or through avatar thumbnails; once an avatar is selected, the corresponding package stored in memory 230 of server 20 is downloaded to client device, where the client operating systems allows loading the package into the appropriate folder of the game application package;
step 192: if the selected game application does not support direct loading, the package downloading and installation in the game application is performed by a dedicated client program which selects and loads the plugin, capable of performing the procedure required for entering into the game data structure and installing the avatar into that data structure.

The skilled person will be able to bring many changes and variants to the present invention as described above. In particular:
although the present invention has been described in its application to game programs executed on the client equipment 10, the present invention can be extended to programs executed on dedicated game consoles. In such case, the avatar package will be transferred from the client equipment to the game console by appropriate means such as Wi-Fi connection or a removable storage, and an avatar loading program will be executed in the game console;
although the present has been described in its application for face avatars, full body avatars, or avatars for other body parts, can be generated with the present invention. In this case, the transition zones between scan areas and model areas shall be determined as a function of the types of areas.

1. A system for generating a 3D personalized avatar for use in particular in gaming applications, comprising:
a computerized server,
a computerized client device,
a bidirectional communications channel between said server and said client device,
a memory in said client device, storing 3D scan data of at least part of a user's body,
a memory in said server for storing said 3D scan data after transmission from said client device through said bidirectional communications channel,
a plurality of 3D model data sets associated to a plurality of gaming systems, stored in said server memory,
a gaming system selector for providing to server information about a gaming system selected for personalized avatar generation,
a personalized 3D avatar generation engine provided in said server and responsive to the selected gaming system for merging said user 3D scan data with a 3D model data set associated with the selected gaming system,
an avatar package generator provided in said server for generating a personalized avatar package containing said merged data, and
an avatar package installer provided in said client device for receiving said package from said server through said communications channel and for making the personalized 3D avatar accessible to the selected gaming system.

2. A system according to claim 1, wherein said user 3D scan data are unoriented scan data, and said server further comprises a 3D scan data analyzer configured for receiving from said client said unoriented 3D scan data, for generating and storing a plurality of 2D renderings of said unoriented 3D scan data from a corresponding plurality of different viewpoints, for performing image analysis on each 2D rendering for identifying and locating characteristic body and/or head areas, for selecting a best 2D view including the best found characteristic areas, and for processing said unoriented 3D scan data so that they refer to head or body axes.

3. A system according to claim 2, wherein said unoriented 3D scan data comprise head data and said 3D scan data analyzer is configured for identifying characteristic areas corresponding to eyes and mouth in said renderings.

4. A system according to claim 3, wherein said 3D scan data analyzer is configured for performing a fine reorientation of the unoriented 3D scan data from the positions of said characteristic areas in the best 2D view.

5. A system according to claim 1, wherein said server comprises a universal scan file generator for generating scan files containing data capable of being merged with a plurality of different formats corresponding to said 3D model data sets.

6. A system according to claim 1, wherein said universal scan file generator is capable of generating a first scan file of higher definition adapted for use by said avatar generation engine and a second scan file of lower definition adapted for display in a client device.

7. A system according to claim 1, wherein said server and said client device are configured for interactive avatar parameter adjustment by transmitting low definition scan data from said server to said client device, for computing at client side changes in the 3D scan aspect in response to parameter changes also made at client side, and for displaying the changed 3D scan aspect as parameters are changed.

8. A system according to claim 7, wherein said client device is configured to transmit the final avatar parameters to said server, said parameters being used by said avatar generation engine for processing said user 3D scan data before merging.

9. A system according to claim 1, wherein said avatar generation engine is configured for determining whether 3D points are located within the scan area, or within the model area, or else in a transition area between the scan and the avatar, and selecting which model data are to be replaced with scan data or combined with scan data based on such determination, for generating a merged 3D structure.

10. A system according to claim 9, wherein the coordinates of a pair of boundaries are associated with the stored 3D models, a first boundary extending between the scan area and the transition area, and a second boundary extending between the transition area and the model area.

11. A system according to claim 10, wherein the coordinates of the merged 3D structure in the transition area are determined by interpolation between scan coordinates and model coordinates.

12. A system according to claim 11, wherein said interpolation uses interpolation coefficients that vary gradually from the first boundary to a second boundary to ensure a smooth shape transition between the 3D scan in the scan area and the 3D model in the model area.

13. A system according to claim 12, wherein said avatar generation engine is further configured to gradually mix the textures of the 3D scan and the textures of the 3D model in the transition area.

14. A computer-implemented method for generating a 3D personalized avatar for use in particular in gaming applications, comprising:
generating and transmitting to a server 3D scan data of at least part of a user's body and storing said scan data in a server memory,
providing a plurality of 3D model data sets associated to a plurality of gaming systems in said server memory,
selecting a particular gaming system among said plurality of gaming systems,
generating a personalized 3D avatar by merging said user 3D scan data with a 3D model data set associated with said selected gaming system,
generating an avatar package containing said merged data in said server,
transmitting said avatar package to a client device connectable to gaming system of the selected type, and
installing said avatar package in said client device for making the personalized 3D avatar accessible to said gaming system.

15. A method according to claim 14, wherein said user 3D scan data are unoriented scan data and the method further includes:
generating from said unoriented 3D scan data a plurality of 2D renderings of said unoriented 3D scan data from a corresponding plurality of different viewpoints,
performing image analysis on each 2D rendering for identifying and locating characteristic body and/or head areas,
selecting a best 2D view including the best found characteristic areas, and
processing said unoriented 3D scan data so that they refer to head or body axes.

16. A method according to claim 15, wherein said unoriented 3D scan data comprise head data and said characteristic areas correspond to eyes and mouth in said renderings.

17. A method according to claim 16, comprising the further step of performing a fine reorientation of the unoriented 3D scan data from the positions of said characteristic areas in the best 2D view.

18. A method according to claim 14, comprising the step of generating from said 3D scan data a universal scan file containing data capable of being merged with a plurality of different formats corresponding to said 3D model data sets.

19. A method according to claim 14, comprising the generation of a first scan file of higher definition adapted for use for avatar generation and a second scan file of lower definition for display in a client device.

20. A method according to claim 14, comprising a further step of adjusting scan parameters by:
transmitting a low-definition scan file from said server to said client device,
performing parameter changes at said client device,
computing at said client device changes in the 3D scan aspect in response to said parameter changes, and
displaying of a client device display the correspondingly changing 3D scan aspect.

21. A method according to claim 20, comprising a further step of transmitting from said client device to said server the final avatar parameters, said parameters being inputted to the avatar generation step.

22. A method according to claim 14, wherein the avatar generation step comprises determining whether 3D points are located within the scan area, or within the model area, or else in a transition area between the scan and the avatar, and selecting which model data are to be replaced with scan data or combined with scan data based on such determination.

23. A method according to claim 22, wherein the coordinates of a pair of boundaries are associated with the stored 3D models, a first boundary extending between the scan area and the transition area, and a second boundary extending between the transition area and the model area.

24. A method according to claim 23, wherein the coordinates of the merged 3D structure in the transition area are determined by interpolation between scan coordinates and model coordinates.

25. A method according to claim 24, wherein said interpolation uses interpolation coefficients that vary gradually from the first boundary to a second boundary to ensure a smooth shape transition between the 3D scan in the scan area and the 3D model in the model area.

26. A method according to claim 25, wherein said avatar generation step further comprises gradually mixing the textures of the 3D scan and the textures of the 3D model in the transition area.
